(19) United States
(12) Patent Application Publication
(10) Pub. No.: US 2002/0116268 A1
(43) Pub. Date: Aug. 22, 2002

(54) Information propagation device, information terminal, information provision system and information provision method

(76) Inventor: Kunio Fukuda, Tokyo (JP)

Correspondence Address: Jay H. Maioli, Cooper & Dunham LLP, 1185 Avenue of the Americas, New York, NY, 10036, US

(21) Appl. No.: 10/077,674

(22) Filed: Feb. 15, 2002

(30) Foreign Application Priority Data
Feb. 21, 2001 (JP) P2001-045696
Oct. 10, 2001 (JP) P2001-313315

(51) Int. Cl. G06F 17/60

(52) U.S. Cl. 705/14

(57) ABSTRACT

Information providing system allowing the user to easily acquire information on an object such as a general-purpose product or relating to an advertisement over a network without having to write the network address. In the present invention, an RF-ID tag storing the mail address of the advertisement sponsor and the URL of the server providing the information are attached for example to an advertisement inside a bus or subway train, and an RF-ID reader is installed in a PDA. A user desiring to obtain this information over the Internet utilizes the PDA to receive the information from the RF-ID tag installed in that advertisement and access the Internet.

### BACKGROUND OF THE INVENTION

1. Field of the Invention

The present invention relates to an information propagation device, information terminal, information provision system and information provision method for conveying information by utilizing RF-ID (Radio Frequency Identification).

2. Description of Related Art

In recent years, many paper advertisements as for example seen in train stations and subway trains, besides the advertisement itself, also list a URL (Uniform Resource Locator) showing the address of the Internet home page of the advertisement sponsor. Because of limited space, a paper-based advertisement cannot show in detail, information such as for a product the sponsor wants to advertise. However by including a URL along with the advertisement, a greater amount of information can be provided to the user on the home page containing detailed information on the product in the paper-based advertisement.

An information providing system of the related art for providing information such as for a product in greater detail over the Internet by including the URL in the paper-based advertisement is shown in FIG. 6, and this information providing system of the related art is described next.

An information provision system 100 of the related art as shown in FIG. 6, is comprised of a paper-based advertisement 101 listing an advertising statement such as for a product, a portable information terminal 102, a mobile communication network 103, an Internet 104, and a server 105 capable of being accessed over the Internet 104.

The advertisement 101 along with the advertising description such as for a product, also includes a URL. This URL is a URL for a home page where information relating to that product can be uploaded over the Internet.

A portable information terminal 102 is a small, portable information terminal. Along with being able to access the Internet 104, this portable information terminal 102 also contains browser software for viewing home pages uploaded over the Internet. By entering a specific URL into this portable information terminal 102, the user accesses a server specially designated by that URL on the Internet 104 and can view the home page indicated by the applicable URL. A portable information terminal 102a is capable of accessing the mobile communication network 103 by radio (or wireless), and a portable information terminal 102b is not capable of accessing the mobile communication network 103 by radio (or wireless). The portable information terminal 102b not having radio access capability, can for example, access the mobile communication network 103 by connecting with a cellular telephone 106.

The mobile communication network 103 is a communication network connected with mobile telephones and is connected to the Internet 104 by relaying through a base station, etc.

A server 105 is an information server on the Internet server 104.

The advertising sponsor for the advertisement 101 first creates a home page containing information relating to the product advertised in the advertisement 101, and uploads that home page to the server indicated by the URL listed in the advertisement 101.

The user viewing the advertisement 101, uses an input device such as a pen to input the URL listed in the advertisement 101 to the portable information terminal 102 and connect to the Internet 104. The portable information terminal 102 connected to the Internet 104, connects to the server 105 designated by that URL, and downloads the home page provided by the applicable URL. The user can then refer to the downloaded home page by using the home page viewing software of the portable information terminal 102.

By utilizing the URL listed in a paper-based advertisement, the information provision system 100 of the related art is therefore capable of providing much information relating to the product in that advertisement.

However, the information provision system 100 of the related art has the problem that input of the URL is complicated and troublesome, since the user himself must rewrite the URL listed in the advertisement 101 into the portable information terminal 102.

Further, the URL is extremely long when listed at the bottom level within that home page so that the task of entering the URL is even more complicated and troublesome. Also, even if the URL is listed at the top of the home page, much time and trouble is required to obtain the desired information if that product information is at the bottom level of the home page.

### SUMMARY OF THE INVENTION

The present invention made in view of the above circumstances of the related art, provides an information propagation device, information terminal, information provision system and information provision method capable of easily acquiring information relating to objects such as of advertisements or general purpose products without the user having to write the network address himself when such information is provided to users over the Internet.

An information propagation device of the present invention comprises an object, an RF-ID (Radio Frequency Identification) tag attached to the object for sending by radio an address of a network server providing information relating to the object as well as information relating to the object.

An information terminal of the present invention comprises an RF-ID tag for receiving radio waves sent from an RF-ID (Radio Frequency Identification) reader attached to an object, and an information acquisition section for accessing the network and acquiring information provided from a server on the network, in which an RF-ID reader receives information from the RF-ID tag relating to the object and the address of a network server providing information relating to the object, and the information acquisition section outputs the related information received from the RF-ID tag or stores the address received by the RF-ID reader, accesses the network and acquires the related information from the address.

An information provision system of the present invention comprises an information propagation device consisting of an object, anRF-ID (Radio Frequency Identification) tag attached to the object for sending by radio frequency waves, an address of a network server providing information relating to the object as well as information relating to the object, and an information terminal including an RF-ID reader for receiving information sent by radio frequency waves from the RF-ID tag, and information acquisition means for accessing the network and acquiring information provided from the network server, in which the information acquisition section has an information terminal for storing the address received by way of the RF-ID reader and/or information relating to the object, and outputting the related information received from the RF-ID tag, or storing the address received from the RF-ID reader, accessing the network, and acquiring the related information from the server.

An information provision method of the present invention comprises the steps of attaching an RF-ID (Radio Frequency Identification) tag to an object for sending information relating to the object and/or an address of a network server providing information relating to the object by radio frequency waves, installing an RF-ID reader for receiving radio frequency waves sent from the RF-ID tag onto an information terminal, storing information relating to the object and/or an address received from the RF-ID reader by radio frequency waves, and outputting the related information received from the RF-ID tag, or storing the address received from the RF-ID reader, accessing the network, and acquiring the related information from the server.

In the information propagation device, information terminal, information provision system and information provision method of the present invention, an RF-ID tag is mounted in an object for sending by radio frequency waves, an address of a network server providing information relating to an object and/or information relating to an object, and information showing the position of a location where the object is installed; and an RF-ID readers mounted in the information terminal for receiving radio frequency waves send from the RF-ID tag; and the related information is output from the RF-ID tag utilizing the information terminal, or the address received from the RF-ID reader is stored and the network accessed, and the related information acquired from the address of the server.

Therefore, when providing information to a user relating to an object such as a general product or advertisement or information for the location where the advertisement is installed or a peripheral map; the information propagation device, information terminal, information provision system and information provision method of the present invention are capable of writing the address included in the advertisement or product instruction manual without the user himself having to write that address, and the information is automatically input to the information terminal so that the related information is acquired easily.

The mail address of an advertising sponsor or the URL of a home page such as for a product advertised for example, in an advertisement in a subway car is automatically input to the information terminal so that the desired home page can be easily viewed. The longitude-latitude or address information of the store is automatically input to the information terminal so that the current location can be easily checked.

The present invention therefore places no burden on the user and is capable of providing a large quantity of information relating to the object.

### BRIEF DESCRIPTION OF THE DRAWINGS

FIG. 1 is an overall system view showing the information provision system of the first embodiment of the present invention.

FIG. 2 is a block diagram of the tag installed in the advertisement and portable information terminal of the information provision system.

FIG. 3 is a system block diagram of the information provision system showing a variation of the first embodiment of the present invention.

FIG. 4 is a system block diagram of the information provision system showing the second embodiment of the present invention.

FIG. 5 is a system block diagram of the information provision system showing the third embodiment of the present invention.

FIG. 6 is a system block diagram of the information provision system of the related art.

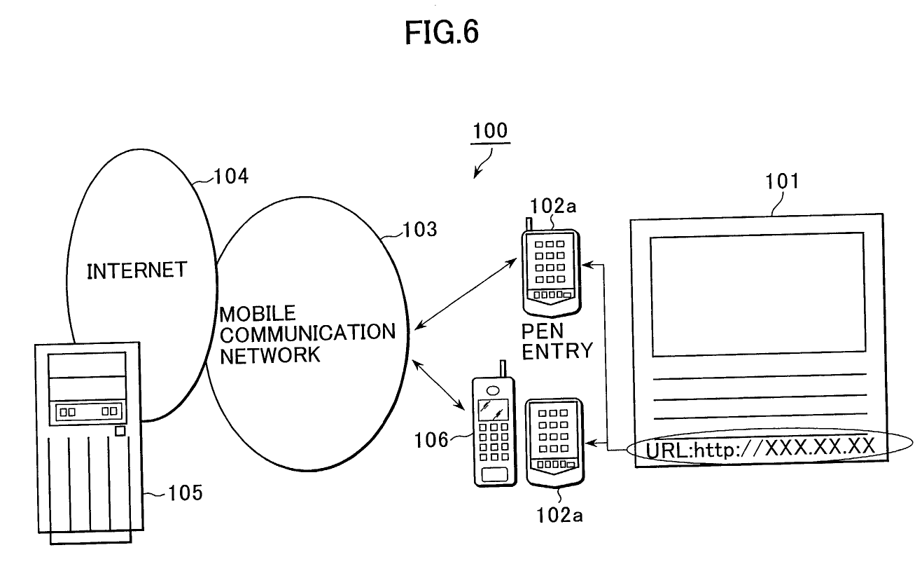

### DETAILED DESCRIPTION OF THE PREFERRED EMBODIMENTS

An information provision system constituting the first embodiment of the present invention is described next while referring to the accompanying drawings.

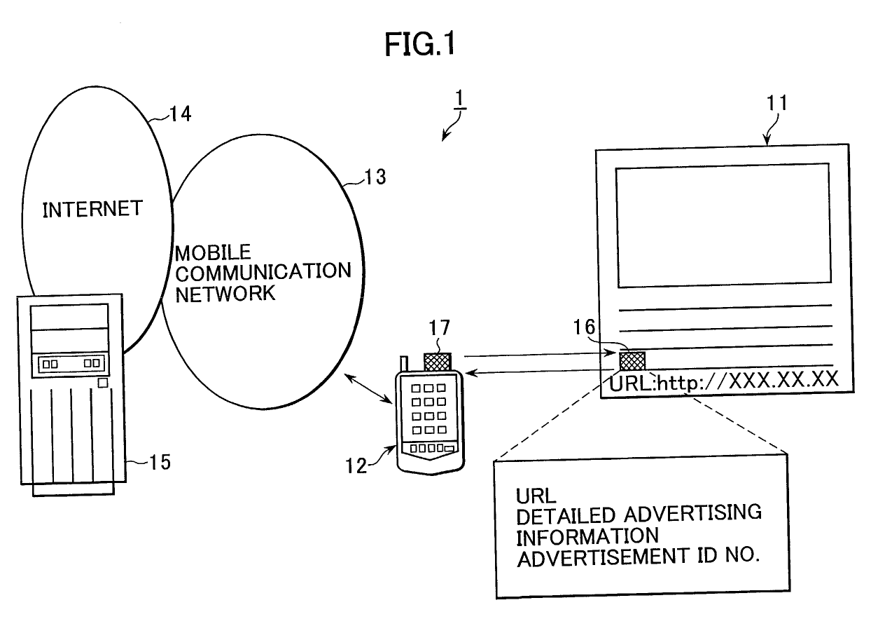

An overall system view showing the information provision system of the first embodiment of the present invention is shown in FIG. 1.

An information provision system 1 is comprised of a paper-based advertisement 11 listing advertising such as for a product, a portable information terminal 12, a mobile communication network 13, an Internet 14, and a server 15 capable of accessing the Internet 14.

Besides containing an advertising description such as for a product, the advertisement 11 is also installed with a tag l6 comprising an RF-ID (Radio Frequency-Identification).

The RF-ID system is comprised of a tag and reader. In this system, a reader is utilized to read out by a non-contact method the information contents stored in the tag. The RF-ID system is also referred to by other names such as ID system or data carrier system, etc. Methods for communicating between the tag and reader are electromagnetic coupling, electromagnetic induction and RF communication, etc. The example here uses the RF communication method utilizing microwaves (for example the 2.4 GHz band). The tag 16 of this example does not use a device to internally generate an electromotive force such as batteries but receives electrical power in high frequency signals supplied from the reader 17 installed in the portable information terminal 12 described later to generate an electromotive force.

The URL, detailed advertisement information and advertisement identification number are the information stored in the tag 16 attached to the advertisement 11. The URL stored in the tag 16 is the Internet home page URL for uploading information relating to the product advertised in the advertisement 11. The detailed advertisement information is for example detailed information relating to that advertisement 11 such as detailed specifications or price tables on the product advertised in the advertisement 11. This detailed information includes for example, information omitted from or incapable of being listed on the paper surface of the advertisement 11. The advertisement identification number is a number for identifying the applicable advertisement 11 and for example is a unique number added to each advertisement

Any method may be used to attach the tag 16, and it may be installed at any position. The tag 16 for example may form a seal, and be directly attached to the advertisement 11. The URL stored on the tag 16 in the advertisement 11 may be listed along with the advertisement description, or need not be listed with the description.

The portable information terminal 12 is a small, portable type information terminal. Besides having a function to access the Internet 14, this portable information terminal 12 contains a browser for viewing home pages uploaded by the Internet server. A reader 17 constituting the RF-ID system is installed in this portable information terminal 12. This reader 17 operates by a radio communication method using microwaves, and reads out (scans) the information (URL, detailed advertisement information and advertisement identification number) stored in the tag 21 attached to the advertisement 11.

The portable information terminal 12 internally stores user information utilized by the terminal. The user information for example is the age of the user, user gender, user occupation, and E-mail address, etc.

If the portable information terminal 12 does not have a radio access function, then it can access the mobile communications network 13 by connecting to an external communications device such as a cellular telephone.

The mobile communications network 13 is a communications network connecting to mobile telephones and is connected to the Internet 14 by relay through a base station, etc.

The server 15 is an information provision server on the Internet 14.

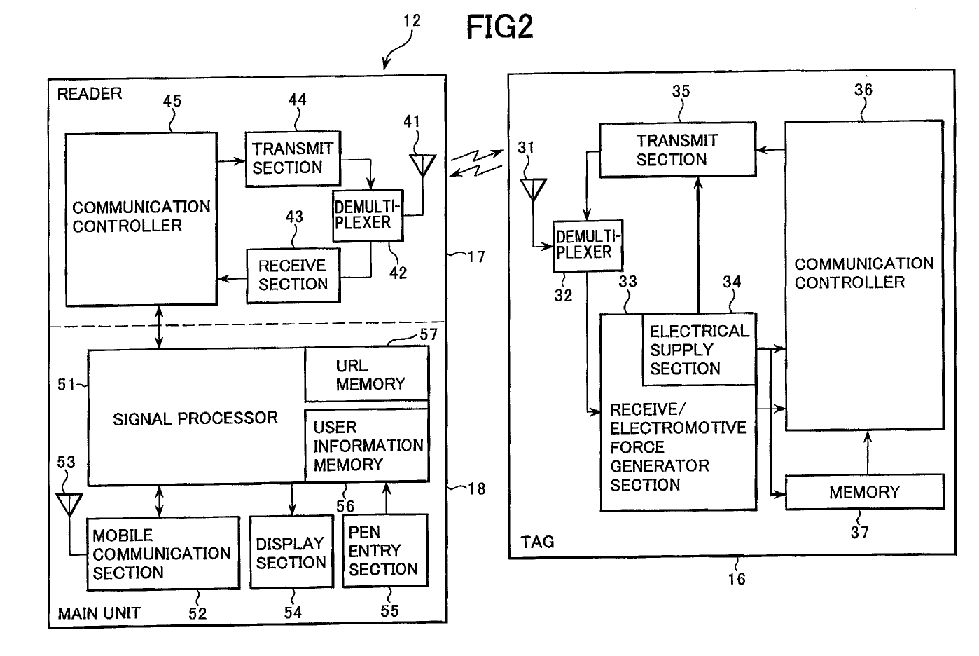

The internal structure of the tag 2 and also the portable information terminal 12 installed in the reader 17 are shown in FIG. 2.

The tag 16 is comprised of an antenna 31, a duplexer 32, a receive/electromotive force generator section 33, an electrical supply section 34, a transmit section 35, a communication controller 36, and a memory 37.

The antenna 31 sends microwave signals to and receives them from the reader 17 of portable information terminal 12.

The duplexer 32 is a joint circuit for both transmitting microwave signals from the tag 16 to the reader 17, and receiving microwave signals at tag 16 from the reader 17.

The receive/electromotive force generator section 33, along with detecting microwave signals received by the antenna 31, and receiving signals sent from the reader 17, also generates an electromotive force (power) from the electrical energy received from these microwave signals. The receive/electromotive force generator section 33 charges the electrical supply section 34 with this generated electrical power.

The electrical supply section 34 supplies charging power to the transmit section 35, a communication controller 36, and a memory 37. The transmit section 35, a communication controller 36, and a memory 37 start operating when power is supplied from the electrical supply section 34.

The transmit section 35 sends the signal output from the communication controller 36 from the antenna 31 as a microwave signal.

The communication controller 36 modulates the signal sent to the reader 17.

The memory 37 stores the URL, detailed advertisement information and advertisement identification number sent to the reader 17.

The portable information terminal 12 on the other hand, is comprised of a reader 17 mounted in a main unit 18.

The reader 17 is comprised of an antenna 41, a duplexer 42, a receive section 43, transmit section 44 and a communication controller 45.

The antenna 41 exchanges (sends and receives) microwave signals with the tag 16 installed in the advertisement 11.

The duplexer 42 is a joint circuit for both transmitting microwave signals to the reader 16 from the tag 16, and receiving microwave signals sent from the tag 16 to the reader 17.

The receive section 43 detects microwave signals received by the antenna 41, and receives signals sent from the tag 16.

The transmit section 44 sends microwave signals to the tag 16 via the antenna 41.

The communication controller 45 demodulates and decodes the received signal. The communication controller 45 is controlled from the main unit 18 of the portable information terminal 12.

The main unit 18 contains a signal processor 51, a mobile communication section 52, a mobile communications antenna 53, a display section 54 and a pen entry section 55.

The signal processor 51 performs overall control of the portable information terminal 12. The user information memory 56 and URL memory storage 57 are contained inside the signal processor 51. The user information memory 56 stores user information such as the user age, gender, occupation, and E-mail address, etc. The URL memory storage 57 stores the advertising identification information, detailed advertising information and the URL send from the tag 16.

The mobile communication section 52 sends and receives radio waves by utilizing the mobile communication antenna 53, and exchanges (sends and receives) data with the base station installed in the mobile communications network 13.

The display section 54 and the pen entry section 55 are formed such as from a tablet consisting of for example a liquid crystal display, and along with displaying information to the user, accept input from a device such as a pen operated by the user.

The process (procedure) when information such as relating to the product advertised in the advertisement 11 is provided on the Internet along with the paper-based advertisement 11 is explained next.

The sponsor of the advertisement 11 first makes a home page containing information relating to the product advertised in the advertisement 11 and, uploads it to a server 15 on the Internet 14 showing the same URL as the URL stored in the tab 16.

The user looking at the advertisement 11 next operates the pen entry section 55 with an input device such as a pen, and sets the portable information terminal 12 to URL receive entry mode.

Next, the signal processor 51 of the portable information terminal 12 that received the setting made in URL receive entry mode, instructs the reader 12 of communication controller 45 to receive and enter information from the advertisement 11.

The reader 12 of communications controller 45 that was instructed to receive and enter information from the advertisement 11, next instructs the transmit section 44 to transmit the signal.

Next, the transmit section 44 that received instruction to transmit the signal sends a microwave signal on the 2.4 GHz band by way of the duplexer 42 and the antenna 41.

The microwave signal sent from the reader 17 in this way, is transmitted to the tag 16 installed in the advertisement 11.

Next, the receive/electromotive force generator section 33 along with receiving the 2.4 GHz band microwave signal transmitted from the reader 17 by way of the antenna 31 and the duplexer 32, also generates an electromotive force (voltage) from the electrical power of this microwave signal, and charges the electrical supply section 34.

The transmit section 35, the communication controller 36, and the memory 37 next start operating when the electrical supply section 34 is charged.

The communication controller 36 that commenced operating, reads out the URL relating to the applicable advertisement 11 stored in the memory 37, and the detailed advertising information and advertising identification number, supplies this information to the transmit section 35, and commands the transmission of the signal.

The transmit section 35 the received the instruction to transmit the signal, sends the URL, detailed advertising information and advertising identification number at a high frequency signal different from the 2.4 GHz band by way of the antenna 31 and the duplexer 32.

The URL, detailed advertising information and advertising identification number are in this way sent from the tag 16 to the reader 17.

Next, the receiver 43 of the reader 17 receives by way of the antenna 41 and duplexer 42, the high frequency signal sent from the tag 17, and supplies this received signal to the communications control section 45.

The communications control section 45 extracts the URL, detailed advertising information and advertising identification number from the received signal, and transfers this information to the signal processor 51 in the main unit 18.

When the above information such as the URL is transferred, the signal processor 51 stores these in the URL memory storage 57.

The signal processor 51, along with starting up the browser software for viewing the home page, connects to the Internet 14 after using the mobile communication section 52 to connect to the mobile communications network 13.

The signal processor 51 accesses the server 15 shown in the URL sent from the tag 16 after searching for it on the Internet 14. When accessing the server 51, the signal processor 51 uploads the user information stored in the user information memory 56 and also the advertisement identification number stored in the URL memory storage 57.

The signal processor 51 then downloads the home page from the server 15 that was accessed.

The user can then refer to the display section 54 on the home page downloaded by using the home page viewing software of the portable information terminal 12.

The signal processor 51 may also display the detailed advertising information to the user by using the download software. The detailed advertising information contains detailed information such as price information that could not be listed on the paper surface of the advertisement 11 as related above.

In the information provision system 1, much information relating for example to a product can be provided to the user over the Internet by mounting a tag 16 comprising an RF-ID system into a paper-based advertisement 11 and storing a URL in that tag.

Also in this information provision system 1, the user can easily acquire related information on the advertisement 11 without having to write the URL himself since the URL providing the information relating to advertisement 11 is input to the portable information terminal 12 in a simple operation.

The URL listing becomes extremely long when located in the bottom-most level in the home page, and searching from the top of the home page for the desired information is a bothersome process, however in the case of the information provision system 1, obtaining the information is extremely easy since there is no need to write the URL.

In the information provision server 1, when the server 15 has been accessed by the portable terminal 12, the identification number of the advertisement 11 and the user information are uploaded to the server 15 so that the advertising sponsor can acquire information on what user viewed what advertisement 11, which will prove useful later on in direct mail distribution service and marketing of that product.

In the information provision server 1, a method for connecting with the home page on the Internet is also provided since the advertisement identification number is matched with the URL of the home page on the Internet, and that advertisement identification number is converted into a URL by a portal server containing the database 18 for converting the advertisement identification number into an Internet home page URL.

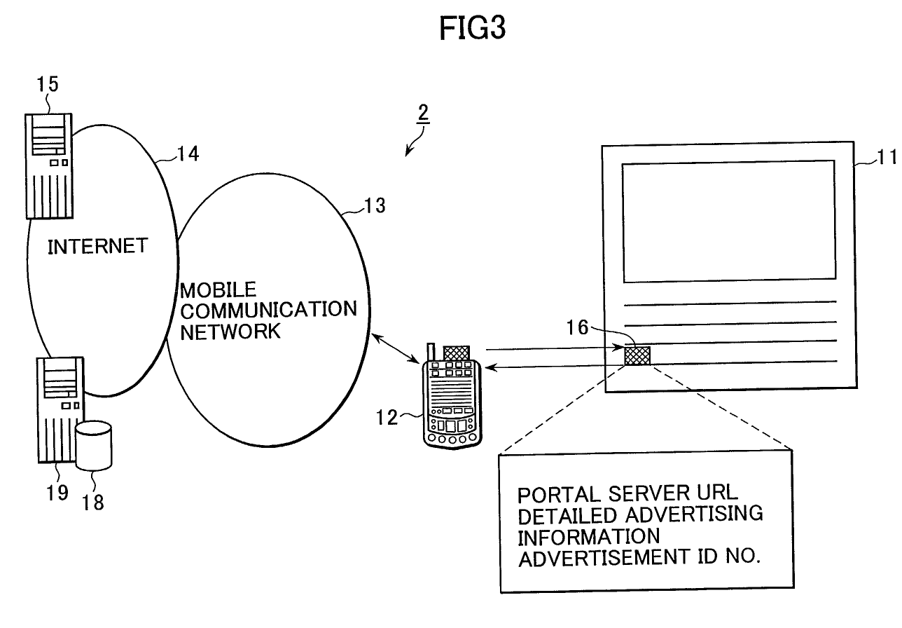

The system structure of an information provision system 2 for this information provision method is shown in FIG. 3. Components of the information provision system 2 having the same functions and applications as the information provision system 1 are assigned the same numbers and a detailed description is omitted.

The advertisement identification number, the detailed advertisement information, and the URL of the portal server 19 containing a database 18 for converting the advertisement identification number matching the URL of the Internet home page into a URL, are all stored as information in the tag 16 attached to the advertisement 11.

The advertisement identification number matches the URL of the Internet home page where information relating for example to a product advertised in the advertisement 11 is uploaded.

A portal server 19 is prepared by the information provision service for allowing the user to view the Internet home page of the advertising sponsor, and contains data for converting the advertisement identification number into the URL of the Internet home page.

The information provision system 2 receives the advertisement identification number stored in the tag 16 and the URL of the portal server 19 on the reader 17.

The signal processor 51 of the portable information terminal 12 connects to the mobile communications network 13 by way of the mobile communication section 52 and connects to the Internet 14.

The signal processor 51 searches the Internet 14 for the server indicated by the URL of the portal server 19 transmitted from the tag 16 and accesses that server.

Next, the signal processor 51 transfers the advertisement identification number received from the reader 17 to the portal server 19.

The portal server 19 acquires the URL of the Internet home page converted into an Internet home page URL by the database 18 and transfers it to the portable information terminal 12.

The portable information terminal 12 is capable of showing the downloaded Internet home page on the display section 54 by the same method as for the information provision system 1.

The server 15 of the URL for the Internet home page may be directly accessed by the portal server 19 using the Internet 14, rather than acquiring the Internet home page URL via the portable information terminal 12.

The signal processor 51 then downloads the home page from the accessed server 15.

The user can then refer to (view) the downloaded home page on the display section 54 by utilizing the home page viewing software on the portable information terminal 12.

When transferring the URL of the home page from the portal server 19, the information provision system 2 can also provide additional services such as proxy sales services relating to the advertisement contents and additional information such as map information services.

An example was described in the first embodiment of the present invention, for installing the tag 16 on the paper-based advertisement 11 for advertising the product, however in the present invention, the tag 16 may be installed in any kind of object. The tag 16 for example may be installed in an electrical product, and a URL for a home page for downloading the instruction manual for that product and a URL for a home page for questions and inquiries regarding that product may be stored in the tag 16.

An information provision system constituting the second embodiment of the present invention is described next.

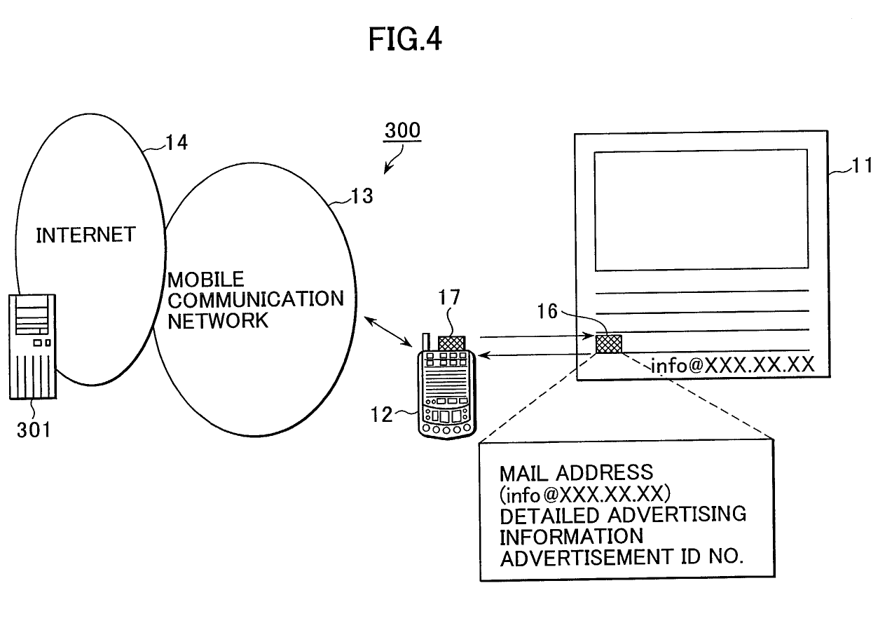

A system structural view of the third embodiment of an information provision system 300 of the present invention is shown in FIG. 4.

Components of the information provision system 300 having the same functions and applications as the information provision system 1 are assigned the same numbers and a detailed description is omitted.

The information provision system 300 is comprised of a paper-based advertisement 11 listing the advertising for the product, a mobile communication network 13, an Internet 14, and a mail server 301 capable of accessing the Internet 14.

In the information provision system 300, the Internet mail address of the advertising sponsor is stored as the stored information in the tag 16 installed in the advertisement 11. This mail address can be utilized for example, for making inquiries to the advertising sponsor.

In the information provision system 300, the mail address stored in the tag 16 is received by the reader 17 installed in the portable information terminal 12. This mail address is stored in the address list in for example the mail software of the portable information terminal 12.

The user can then select the mail address of the advertising sponsor from the address list when desiring to send mail such as inquiries to the advertising sponsor.

Along with starting up the mail software for sending and receiving electronic mail, the signal processor 51 of portable information terminal 12, connects to the mobile communications network 13 using the mobile communication section 52 and connects to the Internet 14.

The signal processor 51 then sends mail entered with the received mail address, to the mail server of the user. The sent mail is conveyed over the Internet to the mail server of the advertising sponsor. The advertising sponsor can then read the mail that was sent by utilizing the mail software for sending and receiving electronic mail.

By storing the mail address of the applicable advertising sponsor in the tag 16, the information provision system 300 can handle product inquiries and other inquiries by (electronic) mail. Also, in the information provision system 300, the mail address such as for the advertising sponsor can be easily input to the portable information terminal 12, and an inquiry message that is input will be instantly conveyed to the advertising sponsor.

Writing of the user mail address is also unnecessary in the information provision system 300, so that mistakes made in entering the mail address are prevented.

The example in the second embodiment of the present invention described installing a tag 16 in the paper-based advertisement 11 for advertising the product, however any kind of object may be used for installing the tag 16. For example, the tag 16 may be installed in a book or magazine, and a mail address for product inquiries or a mail address of the author stored there.

An information provision system 400 of the third embodiment of the present invention is described next.

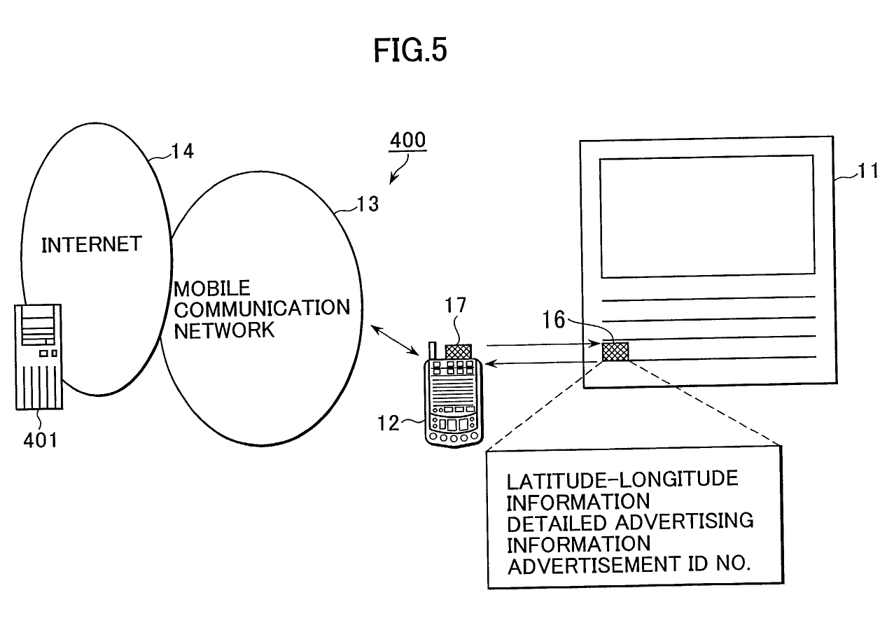

A system structural view of the third embodiment of an information provision system 400 of the present invention is shown in FIG. 5.

Components of the information provision system 400 having the same functions and applications as the information provision system 1 are assigned the same numbers and a detailed description is omitted.

The information provision system 400 is comprised of a paper-based advertisement 11 listing the advertising for the product, a mobile communication network 13, an Internet 14, and a map provision server 401 capable of providing map information by accessing the Internet 14.

In the information provision system 400, the longitude-latitude or address information showing the location where the applicable advertisement is installed, is stored as information in the tag 16 installed in the advertisement 11.

When the user wants to receive longitude-latitude or address information showing the location where the applicable advertisement 11 is installed (with the tag 16), the user receives information from tag 16 on the reader 17 installed in the portable information terminal 12.

Along with starting up the browser software for viewing maps, the signal processor 51 of portable information terminal 12, connects to the mobile communications network 13 using the mobile communication section 52 and connects to the Internet 14.

The signal processor 51 then accesses the server 401 providing map information over the Internet. The server 401 providing the map information searches for maps of the location where the advertisement 11 is installed, by utilizing the longitude-latitude or address information showing the location where the applicable advertisement 11 is installed, received on the reader 17.

The signal processor 51 next downloads from the server, maps around the position where the advertisement 11 is installed.

Utilizing the portable information terminal 12, the user can then refer to the display section 54 showing downloaded maps around the location where the applicable advertisement is installed.

As described above, the information provision system 400 has a tag 16 constituting the RF-ID system installed in the paper-based advertisement 11, and stores longitude-latitude or address information of the applicable advertisement in this tag 16. The information provision system 400 can therefore easily and speedily provide the user with peripheral maps or area maps for the location installed with the advertisement 11. The user can therefore easily as certain the location installed with the advertisement 11.

The example in the third embodiment of the present invention described installing a tag 16 in the paper-based advertisement 11 for advertising the product, however in the present invention, any kind of object capable of being affixed with the tag 16 may be used. The tag 16 may for example be installed in the building floor guide (directory) sign installed within a structure such as a building, and information on positions within the floor may be stored in the tag 16.

What is claimed is:

1. An information propagation device comprising an object; and
an RF-ID (Radio Frequency Identification) tag attached to said object for sending by radio frequency waves, an address on a network server providing information relating to said object and/or information relating to said object.

2. An information propagation device according to claim 1, wherein said RF-ID tag sends any one of a URL (Uniform Resource Locator) for an Internet home page, an HTML (Hyper Text Markup Language) file as information relating to said object, and an Internet mail address by radio frequency waves.

3. An information propagation device according to claim 1, wherein said RF-ID tag stores an advertisement identification number for an advertisement with the matching URL of a home page on the Internet, and sends a URL of a portal server containing a database for converting said advertisement identification number to a URL.

4. An information propagation device according to claim 1, wherein said RF-ID tag sends information identifying said object along with said address by radio frequency waves.

5. An information propagation device according to claim 1, wherein said RF-ID tag sends latitude and longitude information or address information on the location where said object is installed by radio frequency waves.

6. An information terminal comprising:
an RF-ID tag reader for receiving radio frequency waves sent from an RF-ID (Radio Frequency-Identifier) attached to an object; and
information acquisition means for accessing the network and acquiring information provided from said network server,
wherein said RF-ID reader receives from said RF-ID tag, an address of said network server providing information relating to said object and/or information relating to said object, and
said information acquisition means outputs related information received from said RF-ID tag, or stores the address received from said RF-ID tag, accesses said network, and acquires said related information from said server address.

7. An information terminal according to claim 6, wherein said RF-ID reader receives the URL (Uniform Resource Locator) of the Internet home page, and
said information acquisition means accesses the server on the Internet.

8. An information terminal according to claim 6, wherein said RF-ID reader matches and stores an advertisement identification number for an advertisement with the matching URL of a home page on the Internet, and receives by radio frequency waves, a URL of a portal server containing a database for converting said advertisement identification number to an Internet home page URL, and
said information acquisition means accesses the portal server URL on the on Internet, and acquires the URL of the home page on the Internet that is converted from said advertisement identification number, and/or
acquires the URL of the home page on the Internet that is converted from said advertisement identification number at the portal server, accesses the server of the URL of the home page on the Internet from said portal server, and acquires information.

9. An information terminal according to claim 6, wherein said RF-ID reader receives information relating to said object as an HTML (HyperText Markup Language) file by radio frequency waves, and outputs said HTML file.

10. An information terminal according to claim 6, wherein said information acquisition means stores unique user information and sends said unique user information to the applicable server when accessing the server for said address.

11. An information terminal according to claim 6, wherein said RF-ID reader receives said object identification information along with said address by means of radio frequency waves, and
said information acquisition means stores said identification information along with said address, and sends said applicable identification information to said applicable server when accessing server of said address.

12. An information terminal according to claim 6, wherein said RF-ID reader receives an Internet mail address by radio frequency waves, and
said information acquisition means sends mail to said Internet mail address.

13. An information terminal according to claim 6, wherein said RF-ID receives by radio frequency waves, the longitude-latitude or address information of the location where said object is installed, and
said information acquisition means accesses the server on the Internet providing the map information, and acquires map information showing the location where said object is installed, based on said longitude-latitude or address information.

14. An information provision system comprising:
an information propagation device containing an object, an RF-ID (Radio Frequency Identification) tag attached to said object for sending by radio waves an address of a network server providing information relating to said object as well as information relating to said object; and
an information terminal including an RF-ID reader to receive radio waves sent from said RF-ID tag, and information acquisition means for accessing the network and acquiring information provided from the server on said network, wherein said information acquisition means stores information relating to said object and/or stores the address received from said RF-ID reader, and outputs related information received from said RF-ID tag, or stores the address received from said RF-ID tag, accesses said network, and acquires said related information from said server address.

15. An information provision system according to claim 12, wherein said RF-ID tag sends the URL of the Internet home page by radio frequency waves, and
said information acquisition means accesses the server on the Internet.

16. An information provision system according to claim 14 wherein said RF-ID reader matches and stores an advertisement identification number for an advertisement with the matching URL of a home page on the Internet, and sends by radio frequency waves, a URL of a portal server containing a database for converting said advertisement identification number to an Internet home page URL, and
said information acquisition means accesses the portal server URL on the on Internet, and acquires the URL of the home page on the Internet that was converted from said advertisement identification number, and/or
acquires the URL of the home page on the Internet that was converted from said advertisement identification number at the portal server, accesses the server of the URL of the home page on the Internet from said portal server, and acquires information.

17. An information provision system according to claim 14, wherein said RF-ID tag sends information relating to said object as an HTML (Hyper Text Markup Language) file by radio frequency waves, and
said information acquisition means outputs said HTML file.

18. An information provision system according to claim 14, wherein said RF-ID tag sends identification information for said object along with said address by radio frequency waves, and
said information acquisition means stores said identification information along with said address and, sends said applicable identification information to said applicable server when accessing the server of said address.

19. An information provision system according to claim 14, wherein said information acquisition means stores user unique information and sends said applicable user unique information to said applicable server when accessing the server of said address.

20. An information provision system according to claim 14, wherein said RF-ID tag sends the Internet mail address by radio frequency waves, and
said information acquisition means sends mail to said Internet mail address.

21. An information provision system according to claim 14, wherein said RF-ID tag sends by radio frequency waves, latitude and longitude information or address information on the location where said object is installed, and
said information acquisition means accesses the server on the Internet providing the map information, and acquires map information showing the location where said object is installed, based on said longitude-latitude or address information.

22. An information provision method comprising the steps of:
attaching an RF-ID (Radio Frequency Identification) tag for sending by radio frequency waves the address on the network for the server providing information relating to said object as well as information relating to said object, to said applicable object;
installing an RF-ID reader to receive radio waves sent from said RF-ID tag, in an information terminal;
storing information relating to said applicable object and/or an address received by said RF-ID reader; and
outputting said related information received from said RF-ID tag or storing said address received by said RF-ID reader, accessing said network and acquiring said related information from said server address.

23. An information provision method according to claim 22, wherein the URL (Uniform Resource Locator) of the Internet home page is sent by radio frequency waves from said RF-ID, and
the server on the Internet is accessed utilizing said information terminal.

24. An information provision method according to claim 22, wherein said RF-ID tag sends an advertisement identification number for identifying the advertisement, and a URL of a portal server containing a database for converting said advertisement identification number to an Internet home page URL; and
using said portable information terminal, the URL of said portal server on the Internet is accessed, the URL of said Internet home page converted from said advertisement identification number is acquired, and the server for the URL of said Internet home page is accessed, and/or
the URL of said Internet home page converted from said advertisement identification number at said portal server is acquired, and the server for the URL of said Internet home page is accessed from said portal server and information acquired.

25. An information provision method according to claim 22, wherein said RF-ID tag sends information relating to said object as an HTML (Hyper Text Markup Language) file by radio frequency waves, and
said HTML file is output using said information terminal.

26. An information provision method according to claim 22, wherein identification information for said object is sent from said RF-ID tag by radio frequency waves along with said address; and
said identification information is stored along with said address by utilizing said information terminal, and said applicable identification information is sent to applicable said server when accessing the server of said address.

27. An information provision method according to claim 22, wherein said information terminal stores user unique information and, said applicable user unique information is sent to said applicable server when accessing the server of said address.

28. An information provision method according to claim 22, wherein an Internet mail address is sent from said RF-ED tag, and
mail is sent to said Internet mail address utilizing said information terminal.

29. An information provision method according to claim 22, wherein the latitude and longitude information or address information on the location where said object is installed is sent from an RF-ID tag by radio frequency waves, and
the server on the Internet providing the map information is accessed by said portable information terminal, and map information showing the location where said object is installed is acquired, based on said longitude-latitude or address information.
